(19) United States
(12) Patent Application Publication
(10) Pub. No.: US 2018/0000060 A1
(43) Pub. Date: Jan. 4, 2018

(54) Insect Killing Device

(71) Applicants: Jan Craig Meneley, Westminster, CO (US); Taylor Sloan Meneley, Westminster, CO (US)

(72) Inventors: Jan Craig Meneley, Westminster, CO (US); Taylor Sloan Meneley, Westminster, CO (US)

(73) Assignee: AgBio Development Inc., Westminster, CO (US)

(21) Appl. No.: 15/685,386

(22) Filed: Aug. 24, 2017

Related U.S. Application Data
(60) Provisional application No. 62/431,275, filed on Dec. 7, 2016.
(60) Provisional application No. 62/487,749, filed on Apr. 20, 2017.

(51) Int. Cl. A01M 1/04; A01M 1/20; A01M 1/02

(52) U.S. Cl. CPC A01M 1/04; A01M 1/023; A01M 1/20

(57) ABSTRACT

An insect killing device is provided. The device includes one or more of at least one surface including an insecticide therein and an attractant light source, in direct contact with the at least one surface, emitting a light that attracts insects to the at least one surface and maintains the insects on the at least one surface.

### CROSS REFERENCE TO RELATED APPLICATIONS

This application claims priority to earlier filed provisional application No. 62/431,275 filed Dec. 7, 2016, entitled “INSECT KILLING DEVICE”, the entire contents of which are hereby incorporated by reference, and earlier filed provisional application No. 62/487,749 filed Apr. 20, 2017, entitled “INSECT KILLING DEVICE”, the entire contents of which are hereby incorporated by reference.

### FIELD

The present invention is directed to devices for killing flying and crawling insects using an active light source.

### BACKGROUND

Despite many technical advances in preventative entomology, insects still present a serious problem both hygienically and economically. Insects attack crop plants and harvested produce, transport disease-producing organisms, cause pain and discomfort by biting and stinging and create nuisances in many other ways. Various methods have been devised to control insect pests but they are not always satisfactory for many applications. Insecticides are the primary method of insect control, but if they are used improperly, they can be hazardous to birds, fish, animals, and even humans. The search continues for economical, effective, convenient, and non-hazardous methods to control insects. Integrated pest management (IPM) programs have been developed in an effort to reduce pesticide burden in the environment. Many IPM programs for insect control depend on the ability to monitor insect occurrence and populations so as to be able to plan safe and effective control strategies while protecting the beneficial insects needed for a healthy environment

Light traps are commonly used to monitor or reduce insect populations. When insects come to the vicinity of the light they are trapped or killed by adhesive coatings, electrically-charged grids, physical trapping chambers, suction devices, or liquid drowning solutions. Often small insects such as mosquitos can be pulled into the trap with a fan that sucks them into a chamber. Indoors, nuisance flies are killed by electrical traps that employ light bulbs to attract the insect to an electrical grid or an adhesive surface. Each of the above-described systems has limitations.

Adhesive coated surfaces can only hold a limited number of insects and often get fouled by dust and debris, which reduces their trapping ability. The electrocution of insects on electrically-charged grids is accompanied by a sparking and a sound as insect contacts the grid. This sparking can result in production of aerosolized allergens and bacteria into the atmosphere, which is especially noxious when used indoors.

### SUMMARY

The present invention is directed to solving disadvantages of the prior art. In accordance with embodiments of the present invention, a device is provided. The device includes one or more of at least one surface including an insecticide therein and an attractant light source, in direct contact with the at least one surface. The attractant light source emits a light that attracts insects to the at least one surface and maintains the insects on the at least one surface.

One advantage of the present invention is that it provides a device for reliably killing insects. By providing one or more light sources in direct contact with one or more surfaces having insecticide either on the one or more surfaces or impregnated within the one or more surfaces, maximum insect contact is assured. In most cases, the dose of insecticide delivered to an insect is in direct proportion to the number of contacts and length of contact between the insect and the insecticide surface or surfaces.

Another advantage of the present invention is that it may be fabricated in many different forms and arrangements to facilitate indoor or outdoor deployment, aerial or ground mounting, or large or small spaces. This form flexibility may allow various device costs and capabilities to be attained.

Yet another advantage of the present invention is it provides various options to kill insects with little or no power consumption. A light sensor may reduce required power by only enabling the light source during reduced ambient light conditions, including night time. A control circuit may drive the light source with a predetermined duty cycle, thus reducing power requirements. The light source may be self-illuminating, using phosphorescent or radioluminescent light sources.

Additional features and advantages of embodiments of the present invention will become more readily apparent from the following description, particularly when taken together with the accompanying drawings. This overview is provided to introduce a selection of concepts in a simplified form that are further described below in the Detailed Description. It may be understood that this overview is not intended to identify key features or essential features of the claimed subject matter, nor is it intended to be used to limit the scope of the claimed subject matter.

### BRIEF DESCRIPTION OF THE DRAWINGS

FIG. 1 is a diagram illustrating components of an insect killing device in accordance with a first embodiment of the present invention.

FIG. 2 is a diagram illustrating components of an insect killing device in accordance with a second embodiment of the present invention.

FIG. 3 is a diagram illustrating components of an insect killing device in accordance with a third embodiment of the present invention.

FIG. 4 is a diagram illustrating components of an insect killing device in accordance with a fourth embodiment of the present invention.

FIG. 5 is a diagram illustrating components of an insect killing device in accordance with a fifth embodiment of the present invention.

FIG. 6A is a block diagram illustrating components of a light source in accordance with a first embodiment of the present invention.

FIG. 6B is a block diagram illustrating components of a light source in accordance with a second embodiment of the present invention n.

FIG. 6C is a block diagram illustrating components of a light source in accordance with a third embodiment of the present invention.

FIG. 6D is a block diagram illustrating components of a light source in accordance with a fourth embodiment of the present invention

FIG. 6E is a block diagram illustrating components of a light source in accordance with a fifth embodiment of the present invention

FIG. 6F is a block diagram illustrating components of a light source in accordance with a sixth embodiment of the present invention.

FIG. 7 is a block diagram illustrating components of a control circuit in accordance with embodiments of the present invention.

### DETAILED DESCRIPTION

The present application describes various forms of insect-killing devices that may be deployed in various forms and locations. Traps that employ a light, food attractant, or insect pheromone or kairomone attractant can lure the insect to the trap container, but the effectiveness is usually limited by the design of the trap and its ability to hold numerous insects.

The use of insecticide treatments is the prime method of pest control in crops, landscape, forests, houses and other structures. Depending on the formulation of the insecticide, the treatments can be applied as a directed spray to plants or structure surfaces or the treatments may be applied as a granular insecticide to the soil surface or incorporated into the soil. The pest insect is either contacted immediately with the insecticide and killed or the pest insect comes into contact with the insecticide residue that is left on the surface of the plant or structure and is killed later from dermally absorbing a lethal dose or by ingesting a lethal dose of the insecticide.

Some traditional devices only serve to have insects contact an insecticide-treated surface for a brief period. For example, an insecticide-treated mesh may be placed over an opening wherein insects contact the mesh for a short period when passing through the opening. The contact between the insect and the surface is very short for these traditional devices and typically does not provide the time required for the insect to contact a lethal dose of insecticide. The devices described herein overcome these shortcomings by providing mechanisms for insects to contact an insecticide-treated surface for longer periods to receive a lethal dose of insecticide.

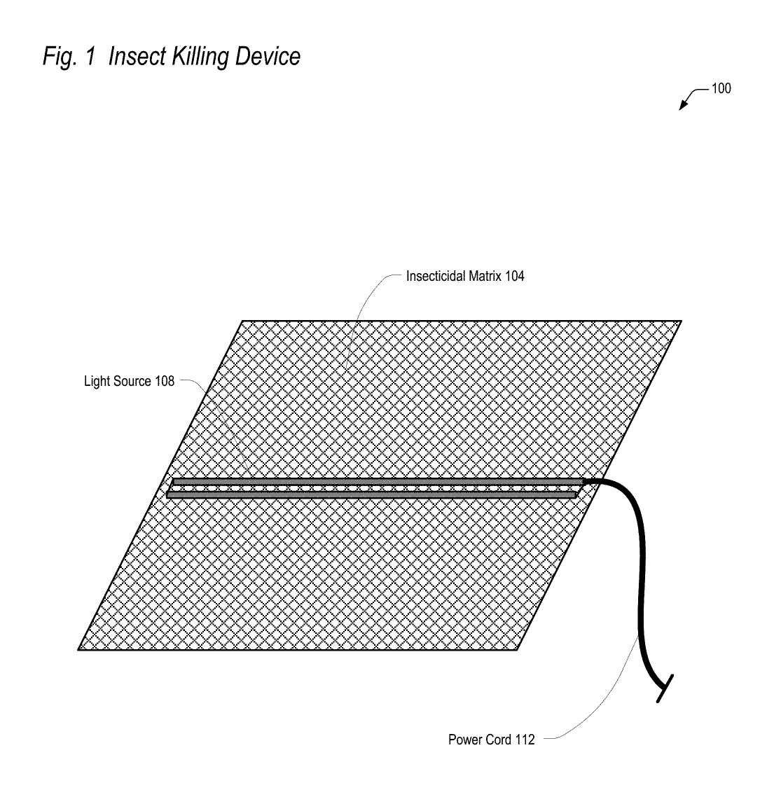

Referring now to FIG. 1, a diagram illustrating components of an insect killing device 100 in accordance with a first embodiment of the present invention is shown. FIG. 1 is a plan view of an exemplary device 100 having a flat insecticidal surface 104 with a light source 108 located adjacent or proximate to the surface to attract insects to the insecticidal surface 104. The insects are attracted to light emitted by the attractant light source 108 for an extended period because the attractant light source 108 is in direct contact with the insecticidal surface 104. This attraction results in the insects maintaining contact with the insecticidal surface 104 for an extended period causing them to receive a lethal dose of the insecticide from the insecticidal surface 104. Insecticidal surface 104 shown in FIG. 1, and in any/all other embodiments, may at least partially include a mesh material. In some embodiments, emitted light from an attractant light source 108 passes through the mesh material.

The present application implements an attractant light source 108 or a plurality of light sources 108 to attract insects to come into contact with an insecticide treated surface 104 or an insecticide impregnated device so as to kill or otherwise immobilize the insects. The light source 108 emits a wavelength or wavelengths of light known to be attractive to the target insects. The attractant light source 108 may emit white light, ultraviolet light, or any predetermined wavelengths of light. In some embodiments, the predetermined wavelengths of light are optimized to attract a specific type or types of insects.

The light source 108 may be powered by direct (DC) or alternating current (AC). The power source for the light source may be provided by batteries, solar cells, or other sources of power. When connected to AC sources, a power cord 112 may be present. Examples of the light source 108 include fluorescent lamps, incandescent lamps, and single or multiple light-emitting diodes. Light sources 108 may be combined as well, including for example a fluorescent lamp and an LED strip or an incandescent lamp in conjunction with a fluorescent lamp.

The attractant light source 108 may emit light of specific wavelength such as UV, blue, yellow, red, green, or purple which is known to attract flying or walking insects. The wavelength of the light emitted by the light source 108 may be a white light, which has a visible spectrum from about 390 to 700 nm (nanometers). The light source 108 may also be a light-emitting diode or multiple LEDs with specific wavelengths such as visible, ultraviolet or infrared wavelengths. An electronic control unit that provides power to the light source may be encased in a holder to protect it from water, humidity, soil, wind or other damaging events. The device can be placed in a plurality of locations, such as being hung in the air, placed on an elevated structure, or placed on a floor or ground as appropriate.

Examples of insect killing devices that include an insect attractant light 108 and insecticidal killing surface 104 are disclosed herein. The attractant light source 108 lures flying insects and/or walking insects to make contact with the insecticidal killing surface. The attractant light source 108 is placed on, in, behind, adjacent, or in close proximity to the insecticide killing surface. The attractant light source 108 serves to attract insects to the killing surface 104 and maintain the insects on the killing surface 104 for a period so that the insecticide on the surface is absorbed by the insects. In some examples, the attractant light source 108 is not separated from the insecticide killing surface 104. For example, the attractant light source 108 may not be a separate unit apart from the killing surface 104 but may be located proximate to or adjacent the killing surface 104. The attractant light source 108 serves to illuminate the surface and/or maintains the insects close to the attractant light source 108 if the surface is not reflective. The attractant light source 108 maintains the insects on the surface 104 for an extended period of exposure to the insecticide. This extended period of exposure to the insecticide increases the amount of insecticide that the insects contact or digest, which increases the probability that the insecticide kills the insects.

The insecticidal killing surface 104 may be made with a plurality of materials including a solid polymer, a polymer fabric, a polymer net, a cellulose pad, a porous polymer pad, or any type of surface on which an insecticide can be applied on at least one side. The killing surface may also be an insecticidal matrix 104 in which the insecticide is impregnated into a solid polymer, a polymer net, a cellulose pad, a porous polymer pad, or polymer or natural fiber or fabric. A surface or multiple surfaces of the device present a sufficient quantity of insecticide to kill or immobilize insects that come in contact with the surface.

The insecticide surface 104 may include a plurality of different insecticides including pyrethroid compounds, carbamate compounds, organophosphate compounds, and insecticide compounds with growth regulating effects. The insecticidal surface 104 may include an insecticide applied to the surface of a solid polymer, a polymer fabric, a polymer net, a cellulose pad, a porous polymer pad, or any type of surface on which an insecticide can be applied or impregnated. In other embodiments, the insecticidal surface 104 may be an insecticide that is impregnated into a solid polymer matrix, a polymer fabric, a polymer net, a cellulose pad, a polymer pad, or any material that can impregnated with an insecticide for release to the surface.

The insecticide surface 104 can comprise pyrethroid compounds from the group consisting of: Etofenprox: 2-(4-ethoxyphenyl)-2-methylpropyl-3-phenoxybenzyl ether, Fenvalerate: (RS)-alpha-cyano-3-phenoxybenzyl (RS)-2-(4-chlorophenyl)-3 methyl-butyrate, Esfenvalerate: (S)-alpha-cyano-3-phenoxybenzyl(S)-2-(4-chloropheny 1)-3-methybutyrate, Fenpropathrin: (RS)-alpha-cyano-3-phenoxybenzyl 2,2,3,3-tetra-methylcyclopropanecarboxylate, Cypermethrin: (RS)-alpha-cyano-3-phenoxybenzy I (1RS)-cis, trans-3-(2,2-dichlorovinyl)-2,2-dimethylcyclopropanecarboxylate, Permethrin: 3-phenoxybenzyl (1RS)-cis, trans-3-(2,2-dichlorovinyl)-2,2-dimethyl cyclopropanecarboxylate, Cyhalothrin: (RS)-alpha-cyano-3-phenoxybenzyl(Z)-(1RS)-cis-3-(2-chloro-3,3,3-trifluoroprop-1-enyl)-2,2-dimethylcyclopropanecarboxylate, Deltamethrin: (S)-alpha-cyano-3-phenoxybenzy I (1R)cis-3-(2,2-dibromoviny 1)-2,2-dimethylcyclopropancarboxylate, Cycloprotbrin: (RS)-alpha-cyano-3-phenoxybenzy I (RS)-2,2-dichloro-1-(4-ethoxyphenyl)cyclopropanecarboxylate, Fluvalinate: (alpha-cyano-3-phenoxybenzyl N-(2-chloroalpha, alpha, alpha-trifluoro-p-toly 1)-D-valinate), Bifenthrin: (2-methylbiphenyl-3-ylmethyl)O(Z)-(1RS)-cis-3-(2-chloro-3,3,3-trifluoro-1-propenyl)-2,2-dimethylcyclopropanecarboxylate, 2-methy 1-2-(4-bromodifluoro-methoxypheny 1)propyl (3-phenoxybenzyl)ether, Tralomethrin: (S)-alpha-cyano-3-phenoxybenzy I (1R-cis) 3((1′RS)(1′,2′,2′,2′-tetrabromoethyl))-2,2-dimethyl-cyclopropanecarboxylate, Silafluofen: 4-ethoxyphenyl (3-(4-fluoro-3-phenoxyphenyl) propyl)dimethylsilane, D-fenothrin: 3-phenoxybenzyl (1R)-cis, trans)-chrysanthemate, Cyphenothrin: (RS)-alpha-cyano-3-phenoxybenzyl (1Rcis, trans)-chrysanthemate, D-resmethrin: 5-benzyl-3-furylmethyl (1R-cis, trans)-chrysanthemate, Acrinathrin: (S)-alpha-cyano-3-phenoxybenzy I (1R-cis (Z))-(2,2-dimethyl-3-(oxo-3-(1,1,1,3,3,3-hexafluoropropyloxy)propeny I(cyclopropanecarboxylate, Cyfluthrin: (RS)-alpha-cyano-4-fluoro-3-phenoxybenzy I 3-(2,2-dichlorovinyl)-2,2-dimethylcyclopropane-carboxylate, Tefluthrin: 2,3,5,6-tetrafluoro-4-methylbenzyl (1RS-cis (Z))-3-(2-chloro-3,3,3-trifluoroprop-1-enyl)-2,2-dimethylcyclopropanecarboxylate, Transfluthrin: 2,3,5,6-tetrafluorobenzyl (1R-trans)-3-(2,2-dichlorovinyl)-2,2-dimethylcyclopropane-carboxylate, Tetramethrin: 3,4,5,6-tetrahydrophthalimidomethyl (1RS)-cis, trans-chrysanthemate, Allethrin: (RS)-3-allyl-2-methyl-4-oxocyclopent-2-enyl (1RS)-cis, trans-chrysanthemate, Prallethrin: (S)-2-methyl-4-oxo-3-(2-propynyl)cyclopent-2-enyl (1R)-cis, trans-chrysanthemate, Empenthrin: (RS)-1-ethynyl-2-methyl-2-pentenyl (1R)cis,trans-chrysanthemate, Imiprothrin:2,5-dioxo-3-(prop-2-ynyl)imidazolidin-1-ylmethyl(1R)-cis,trans-2,2-dimethyl-3-(2-methyl-1-propenyl)-cyclopropanecarboxylate, D-flamethrin: 5-(2-propynyl)-furfuryl (1R)-cis,transchrysanthemate, and 5-(2-propynyl) furfuryl 2,2,3,3-tetramethylcyclopropanecarboxylate; and combinations thereof.

The insecticide surface 104 can comprise carbamate compounds selected from the group consisting of: Alanycarb: S-methyl-N[[N-methyl-N-[N-benzyl-N(2-ethoxy-carbonylethyl) aminothio] carbamoyl]thioacetimidate, Bendiocarb: 2,2-dimethyl-1,3-benzodioxol-4-yl-methyl-carbamate, Carbary: 1-naphthyl N-methylcarbamate, Isoprocarb: 2-(1-methylethyl) phenyl methylcarbamate, Carbosulfan: 2,3 dihydro-2,2-dimethyl-7-benzofuranyl [(dibutylamino)thio] methylcarbamate, Fenoxycarb: Ethyl [2-(4-phenoxyphenoxy)ethyI]carbamate, Indoxacarb: Methyl-7-chloro-2,3,4a,5-tetrahydro-2-[methoxycarbonyl(-4-trifluoromethoxyphenyl)], Propoxur: 2-isopropyloxyphenol methylcarbamate, Pirimicarb: 2-dimethylamino-5,6-dimethyl-4-pyrimidinyl-dimethyl-carbamate, Thidiocarb: Dimethyl N,N′(thiobis((methylimino)carbonoyloxy) bisethanimidiothioate), Methomyl: S-methyl N-((methylcarbamoyl)oxy)thioacetamidate, Ethiofencarb: 2-((ethylthio)methyl)phenyl methylcarbamate, Fenothiocarb: S-(4-phenoxybutyl)-N,N-dimethyl thiocarbamate, Cartap: S, S′-(2-5-dimethylamino)trimethylene)bis(thiocarbamate)hydrochloride, Fenobucarb: 2-sec-butylphenylmethyl carbamate, 3,5-dimethylphenyl-methyl carbamate, Xylylcarb: 3,4-dimethylphenyl-methylcarbamate, and combinations thereof.

The insecticide surface 104 can comprise organophosphate compounds selected from the group consisting of: Acephate: O,S-dimethyl acetylphosphoroamidothioate, Azamethiphos: S-(6-chloro-2,3-dihydro-oxo-1,3-oxazolo [4,5-b]pyridin-3-ylmethyl phosphorothioate, Chlorpyrifos: 0,0-diethyl-O-(3,5,6-trichloro-2-pyrinyl) phosphorothioate, Chlorpyriphos-methyl: 0,0-dimethyl 0-(3,5,6-trichloro-2-pyridinyl) phosphorothioate, Cyanophos: 0,0-dimethyl 0-(4-cyanophenyl) phosphorothioate, Etrimphos: 0-6-ethoxy-2-ethyl-pyrimidin-4-yl-O,O-dimethyl-phosphorothioate, Fenthion: 0,0-dimethyl-0[-3-methyl-4-(methylthio) phenyl phosphorothioate, Fenitrothion: 0,0-dimethyl 0-(4-nitro-m-tolyl) phosphorothioate, Diazinon: 0,0-diethyl-0-(2-isopropyl-6-methyl-4-pyrimidinyl) phosphorothioate, Dimethoate: ((0,0-dimethyl S-(n-methylcarbamoylmethyl) phosphorodithioate Formothion: S[2-fannylmethy!amino]-2-oxoethy 1]-0,0-dimethyl phosphorodithioate, Malathion: 0,0-dimethyl phosphorodithioate ester of diethyl mercaptosuccinate, Phenthoate: 0,0-dimethyl S-(alpha-ethoxycarbonylbenzyl)-phosphorodithioate Phoxim: 2-(diethoxyphosphinothoyl oxyimino)-2-phenylacetonitrile, Pirimiphos-Etyl: 0,0-diethyl 0-(2-(diethylamino) 6-methyl-pyrimidinyl) phosphorothioate, Pirimiphos-Methyl: 0[2-(diethylamino)-6-methyl-4-pyrimidinyl]O,O-dimethyl phosphorothioate, Pyraclofos: (R, S)[4-chlorophenyl)-pyrazol-4-yl]-O-ethyl S-n-propyl phosphorothioate, Pyridaphenthion: 0-(1,6-dihydro-6-oxo-1-phenylpyrazidin-3-yl) 0,0-diethyl phosphorothioate, Temephos: (0,0′(thiodi-4-1-phenylene) 0,0,0,0-tetramethyl phosphorodithioate, and combinations thereof.

The insecticide surface 104 can comprise insecticide compounds selected from the group consisting of: neonicotioids as acetamidiprid and imidacloprid: 1-(6-chloro-3-pyridylmethyl)-N-nitro-2-imidazolidinimine, pyridins as pyriproxyfen: 2-[1-+methyl-2-(4-phenoxyphenoxy)ethoxyy]pyridine, pyrimidines as pyremidifen: 5-chloro-N-(2,-[4-(2-ethoxyethy 1)-2,3-dimethy1-phenoxy]-ethyl 1)-6-ethylpyrimidin-4-amin, quinazoliner as fenazaquin: 4-[[-(1,1-dimethylethyl)phenyl, pyrazoler and phenyl, pyrazoles as dihydropyrazole, fipronile, tebufenpyrad, and fenpyroproximate: 1,1-dimethyl ethyl-4-[[[[(1,3-dimethyl-5-phenoxy-1H-pyrazol-4-yl)-methylene]ammo]oxy]methyl] benzoate], pyrazoner as tebufenpyrad, carbonitrils as vaniliprol, hydrazins as tebufenozide, hydrazons, azomethins, diphenyls as bifenazate, benzoylurea and derivatives thereof and combinations thereof.

The insecticide surface 104 can comprise insecticide compounds with growth regulating effect such as: (alfa-4-(chloro-alpha-cyclopropylbenzylidenamino-oxy)p-tolyl)-3-(2,6-difluorobenzoyl)urea, Diflubenzuron: N-(((3,5-dichloro-4-(1,1,2,2-tetrafluoroethoxy)phenylamino)carbonyl) 2,6 difluoro benzamid, Triflumuron: 2-chloroN-(((4-)trifluoromethoxy)phenyl)-amino)carbonyl)benzamide, a Triazin such as N-cyclopropyl-1,3,5-triazine-2,4,6-triamin, and combinations thereof.

The insecticidal killing surface 104 may be colored such as white, yellow, green, blue, red, brown or other colors known to attract insects in daylight or when illuminated by artificial light. Other insect attractants such as pheromones, kairomones, or food attractants can be combined with the insect killing device to increase attractancy. The use of an insecticidal killing surface 104 obviates the need for a glue board, or other adhesive surface to entrap insects. The insecticidal killing surface 104 further obviates the need for an insect drowning solution in a trap, the need for an electrical grid to electrocute insects, and the need for a complicated trapping chamber designed in such a way that insects have difficulty escaping.

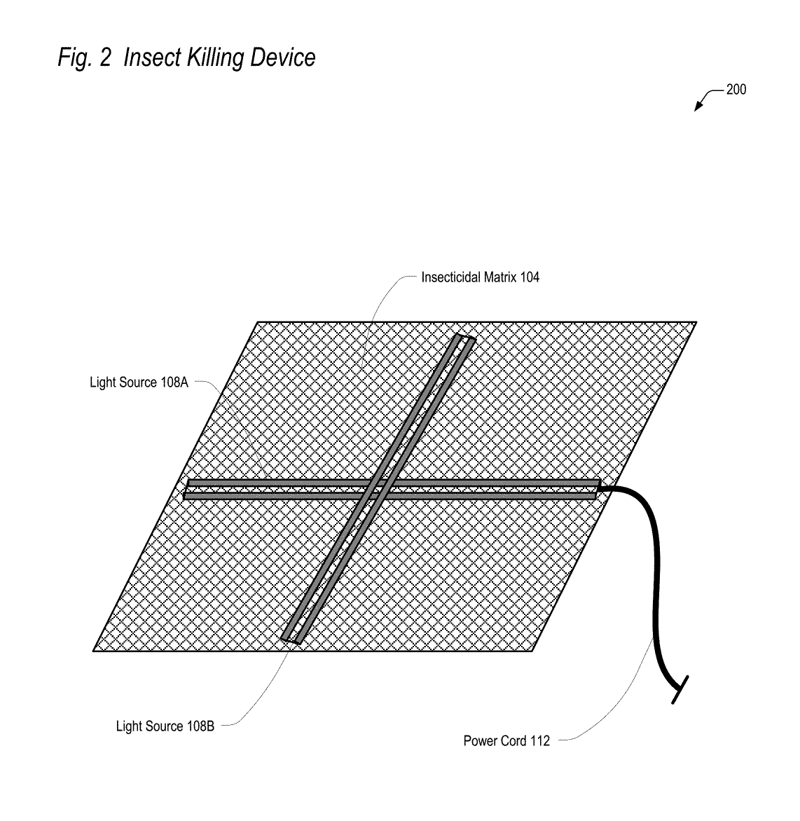

Referring now to FIG. 2, a diagram illustrating components of an insect killing device 200 in accordance with a second embodiment of the present invention is shown. FIG. 2 is a plan view of an example of a device 200 having a flat insecticidal surface 104 with a horizontal light source 108A and a vertical light source 108B in direct contact with the insecticidal surface 104 to attract insects to the insecticidal surface 104. The device of FIG. 2 provides more attractant lights than the device of FIG. 1, so as to attract more insects to the insecticidal surface 104. Other embodiments of the device 200 include attractant lights 108 located at different locations. These embodiments attract insects to greater portions of the insecticidal surface 104 and maintain the insects on these greater portions of the insecticidal surface 104.

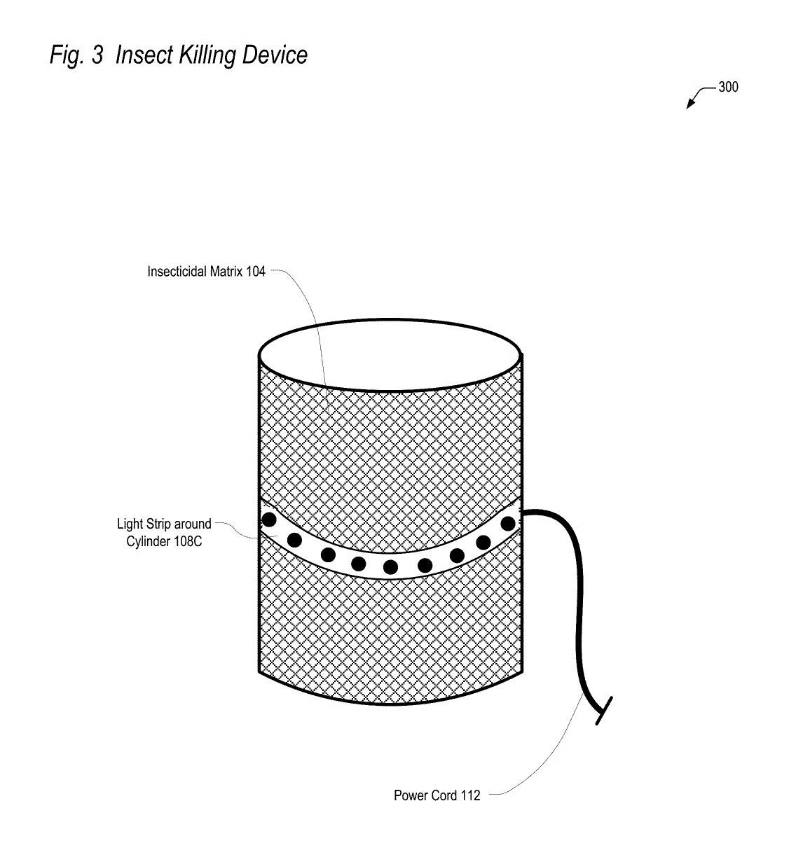

Referring now to FIG. 3, a diagram illustrating components of an insect killing device 300 in accordance with a third embodiment of the present invention is shown. FIG. 3 is an isometric view of an example of a device 300 having a cylindrical insecticidal surface 104 with a lamp strip 108C that encircles the cylinder to attract insects to the cylinder surface in a 360 degree angle. Because the surface of the cylinder constitutes an insecticidal surface 104, the insects receive lethal doses of insecticide when they are maintained on the insecticidal surface 104. The cylindrical shape of the device 300 serves to attract insects from any angle relative to the device 300 and into contact with the insecticidal surface 104. In non-planar embodiments of the present invention, such as illustrated with respect to FIGS. 3-5, the at least one surface is at least one surface of a structure and wherein the attractant light source 108 is located within the structure.

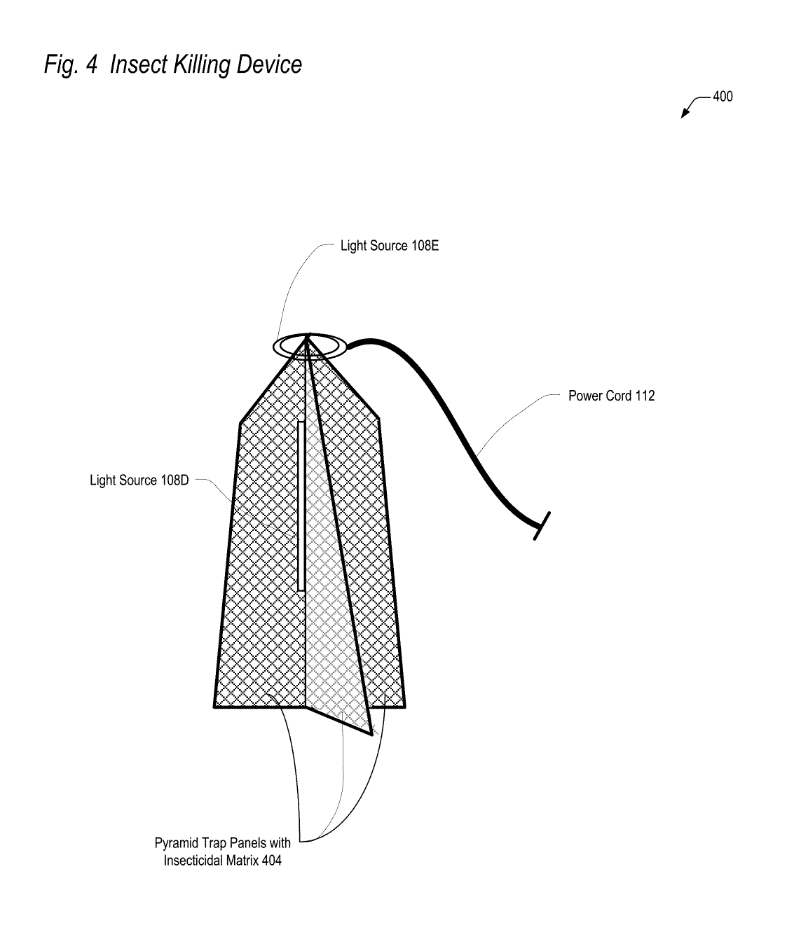

Referring now to FIG. 4, a diagram illustrating components of an insect killing device 400 in accordance with a fourth embodiment of the present invention is shown. FIG. 4 is an isometric view of a pyramid-type device 400, which is covered or impregnated with an insecticidal surface 404. An insect attractant light 108E may be placed at the top of the pyramid for a 360 degree attraction angle or between panels constituting the insecticidal surface 404 around the pyramid for 360 degree attraction of insects.

The insect killing device may have the insecticidal killing surface 404 on one side, two sides, or multiples sides of the device. The device can be square, rectangular, triangular, diamond, circular, oval, cylindrical, pyramidal, convex, concave, or any other geometric shape. The attractant light sources 108D, 108E may be positioned on one side, two sides, or multiple sides of the device to attract insects. Additionally, the insect killing device 400 may be positioned in order to attract insects to insecticidal killing surface or surfaces.

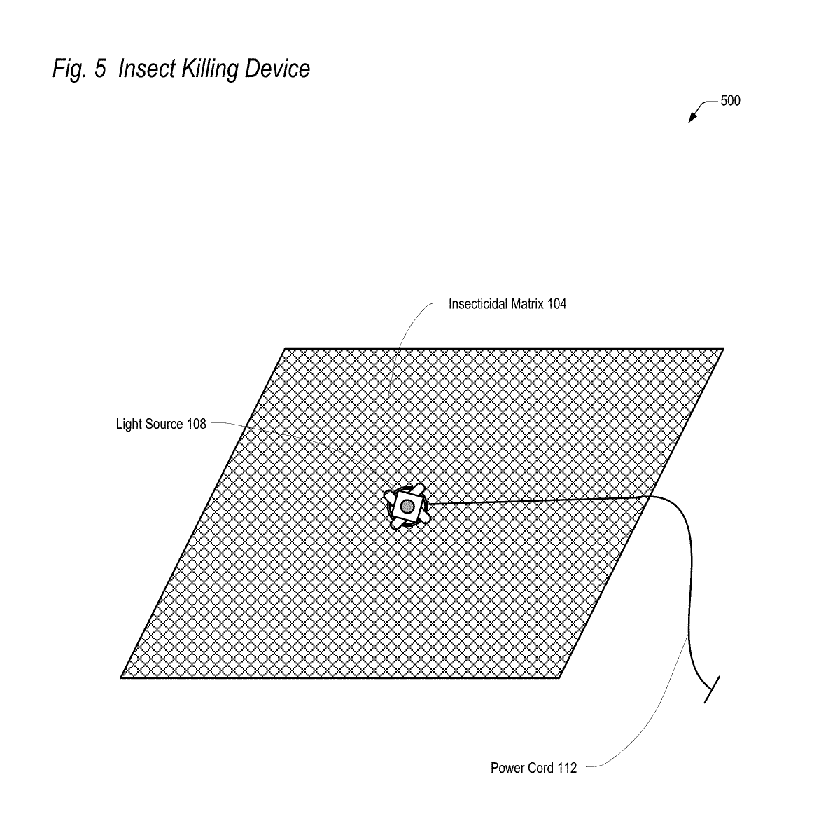

Referring now to FIG. 5, a diagram illustrating components of an insect killing device 500 in accordance with a fifth embodiment of the present invention is shown. FIG. 5 is an isometric view of a device 500 with a point light source 108 generally centered on a sheet of insecticidal matrix 104. The light source 104 includes a central LED that projects light in all directions and four horizontally-oriented LEDs that each project light across the sheet of insecticidal matrix 104. An example of the multiple LED light source is part number 194-×5-LAN available at https://www.superbrightLEDs.com, which is a 30 Lumen Type 194 Miniature Wedge device with 5 LEDs.

In other embodiments, the insect-killing devices 100-500 may be shaped in a variety of configurations such as square, triangular, rectangular, diamond, circular, oval, cylindrical, pyramidal, convex, concave or any geometrical shape. Insect-killing devices may be shaped regularly, irregularly, symmetrically, or asymmetrically.

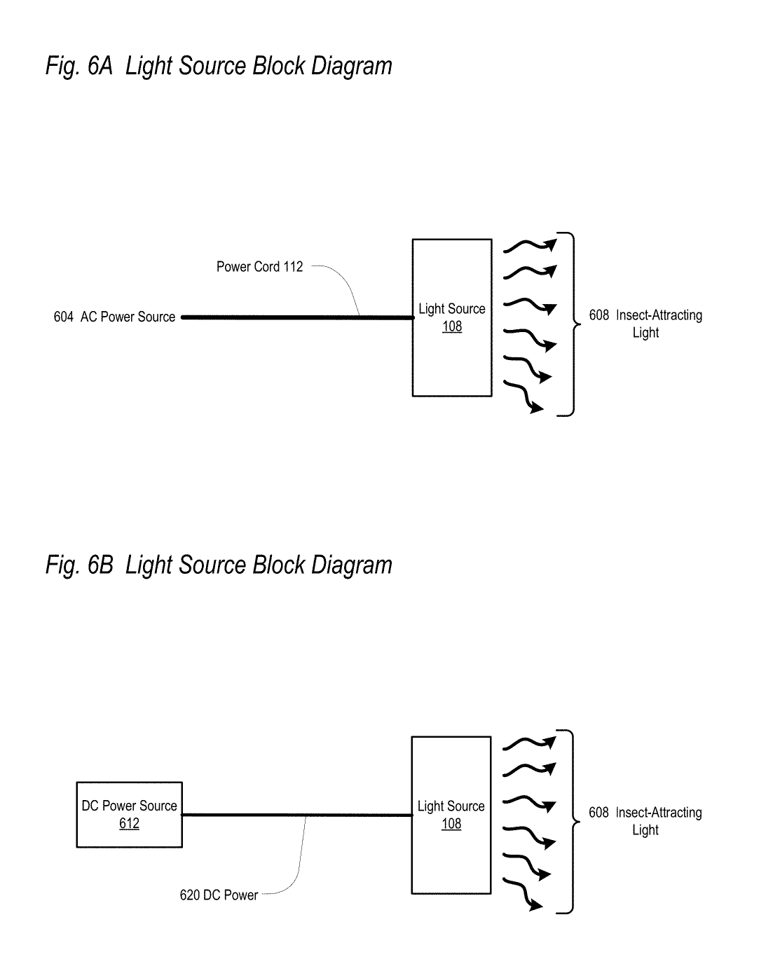

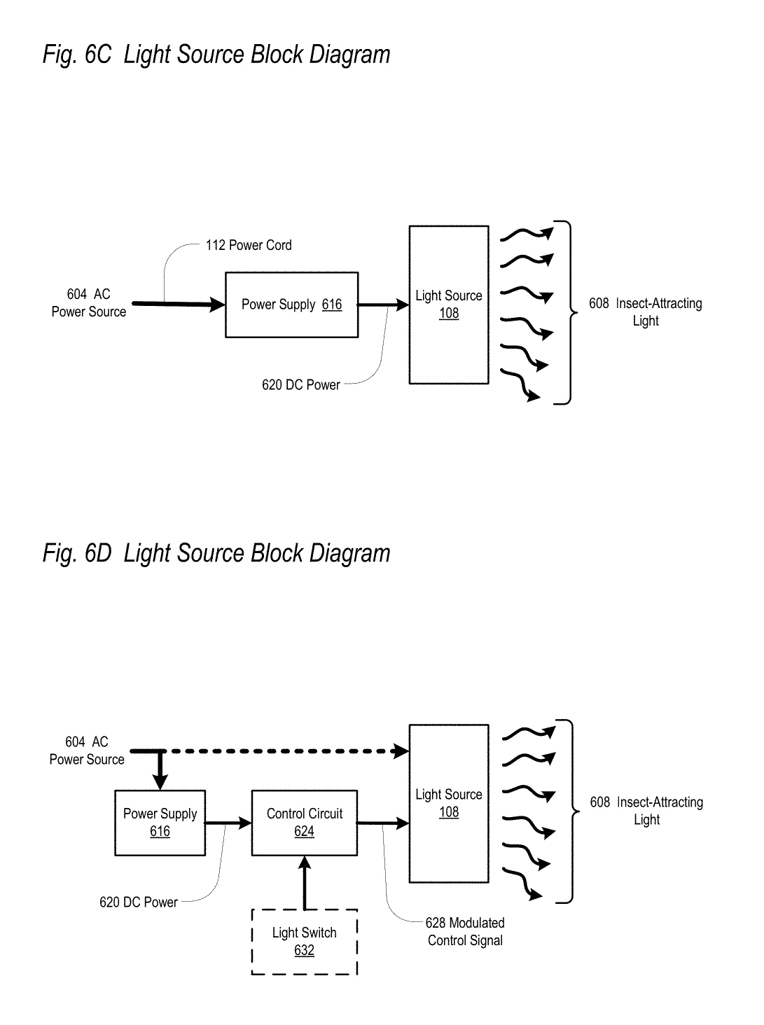

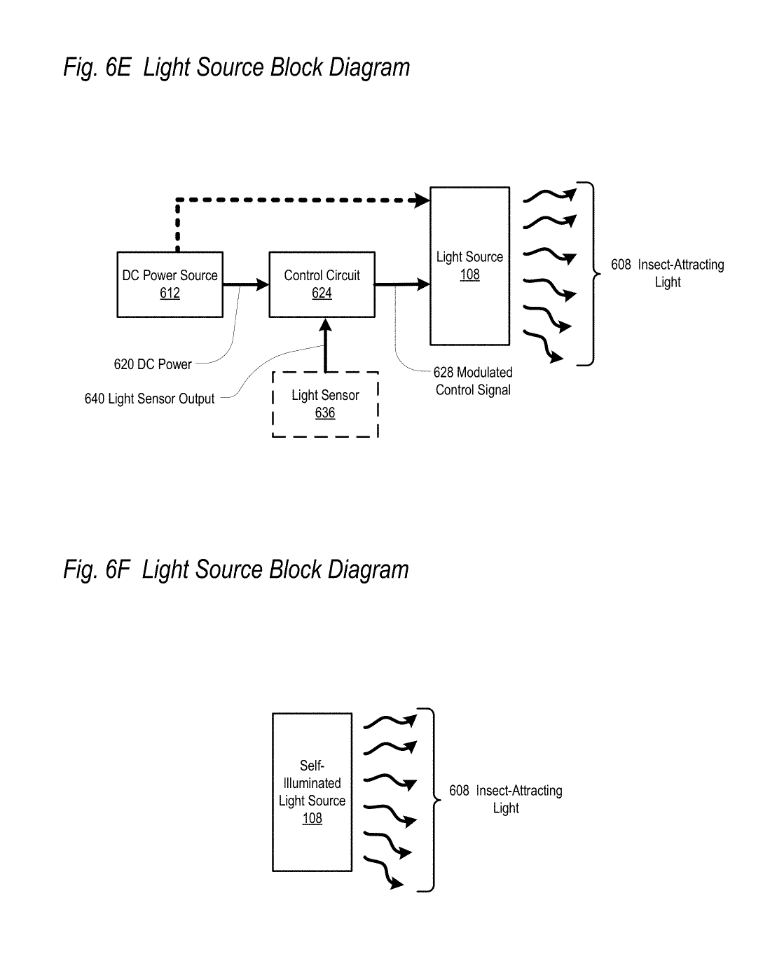

Referring now to FIG. 6A, a block diagram illustrating components of a light source 108 in accordance with a first embodiment of the present invention is shown. In a simple form, a light source 108 is directly connected to an AC power source 604 through a power cord 112, and emits insect-attracting light 608. The light 608 emits light as long as the power cord 112 is connected to the active AC power source 604. An example of the embodiment illustrated in FIG. 6A is an incandescent light bulb 108 and fixture plugged into an AC power source 604. Fluorescent light sources 108 generally require a ballast or similar device, and that may be included in light source 108.

Referring now to FIG. 6B, a block diagram illustrating components of a light source 108 in accordance with a second embodiment of the present invention is shown. In another simple form, a light source 108 is directly connected to a DC power source 612. The DC power source 612 is typically one or more batteries or other form of self-contained DC power. DC power source 612 provides DC power 620 to light source 108, and emits insect-attracting light 608.

Referring now to FIG. 6C, a block diagram illustrating components of a light source 108 in accordance with a third embodiment of the present invention is shown. In the third embodiment, a power supply 616 converts AC power source 604 into DC power 620, for light sources 108 that required DC power 620 instead of light sources 108 that require AC power, as shown in FIG. 6A.

Referring now to FIG. 6D, a block diagram illustrating components of a light source 108 in accordance with a fourth embodiment of the present invention is shown. In the embodiment illustrated in FIG. 6D, a power supply 616 provides DC power 620 to a control circuit 624. The control circuit 624 is coupled to the attractant light source 108, provides a modulated control signal 628 to the light source 108 which may control various aspects of the insect-attracting light 608. In one embodiment, the control circuit 624 modulates brightness of the attractant light source 108. In another embodiment, the control circuit 624 modulates light wavelength of the attractant light source 108. In the embodiment illustrated, an AC power source 604 provides AC power to both the power supply 616 and the light source 108. In other embodiments, the AC power source 604 is only provided to the power supply 616, and not directly to the light source 108 (i.e., for a DC-powered light source 108). In this case, the modulated control signal 628 is modulated DC power 620.

In some embodiments, an optional light switch 632 enables or disables the control circuit 624 under user control. When enabled, the control circuit 624 provides the modulated control signal 628 or modulated DC power 620 to the light source 108. When disabled, the control circuit 624 blocks the modulated control signal 628 or modulated DC power 620 to the light source 108.

The control circuit 624 may modulate the brightness or wavelength of the insect attracting light 608 emitted by the light source 108. In one embodiment, the modulated control signal 628 is duty-cycle modulated to directly control brightness of the light source 108. For higher duty cycles (i.e. when the “on” time is greater than the “off” time), the brightness of the insect-attracting light 608 is higher. For lower duty cycles (i.e. when the “off” time is greater than the “on” time), the brightness of the insect-attracting light 608 is lower. In another embodiment, the modulated control signal 628 provides a specific wavelength of insect-attracting light 608. The specific wavelength may determine the band of light 608 produced by the light source 108, such as ultraviolet, visible light, infrared light, etc., but also may designate a specific color of the insect-attracting light 608. It is well-known that certain insects are attracted to certain light wavelengths more than other insects, and that light wavelength may be adjusted in order to attract a specific type or types of insects. In one embodiment, control circuit 624 includes a user control to adjust the wavelength of insect-attracting light 608. In another embodiment, control circuit 624 may be set to produce a specific wavelength of insect-attracting light 608. In yet another embodiment, control circuit 624 may include a processor and/or memory to produce variations in wavelengths of insect-attracting light 608 according to a programmed schedule or sequence based on time or other factors.

Referring now to FIG. 6E, a block diagram illustrating components of a light source 108 in accordance with a fifth embodiment of the present invention is shown. In the embodiment illustrated in FIG. 6E, a DC power source 612 provides DC power 620 to a control circuit 624. The control circuit 624 provides a modulated control signal 628 to the light source 108 which may control various aspects of the insect-attracting light 608. In the embodiment illustrated, the DC power source 612 provides DC power 620 to both the control circuit 624 and the light source 108. In other embodiments, the DC power source 612 is only provided to the control circuit 624, and not directly to the light source 108. In this case, the modulated control signal 628 is modulated DC power 620.

In some embodiments, including those using an AC power source 604, an optional light sensor 636 provides a light sensor output 640 to the control circuit 624 under user control. Light sensor output 640 generally provides a variable voltage level corresponding to the amount of ambient light detected by the light sensor 636. The control circuit 624 provides the modulated control signal 628 or modulated DC power 620 to the light source 108, based on the light sensor output 640. In general, the light sensor output 640 corresponds to the modulated control signal 628 such that modulated control signal 628 is proportional to the ambient light level detected by the light sensor 636. In one embodiment, the control circuit 624 is enabled when ambient light impinging the light sensor 636 is below a predetermined level. The insect killing device is configured to only a minute light from the light source 108 when the control circuit 624 is enabled. The predetermined level corresponds to desk or evening light levels and in some embodiments may be stored in a memory device 708 within the control circuit 624. Operating in this way, the control circuit 624 is configured to maintain light source 108 brightness in proportion to the light sensor output 640.

The control circuit 624 may modulate the brightness or wavelength of the insect attracting light 608 emitted by the light source 108. In one embodiment, the modulated control signal 628 is duty-cycle modulated to directly control brightness of the light source 108. For higher duty cycles (i.e. when the “on” time is greater than the “off” time), the brightness of the insect-attracting light 608 is higher. For lower duty cycles (i.e. when the “off” time is greater than the “on” time), the brightness of the insect-attracting light 608 is lower. In another embodiment, the modulated control signal 628 provides a specific wavelength of insect-attracting light 608. The specific wavelength may determine the band of light 608 produced by the light source 108, such as ultraviolet, visible light, infrared light, etc., but also may designate a specific color of the insect-attracting light 608. It is well-known that certain insects are attracted to certain light wavelengths more than other insects, and that light wavelength may be adjusted in order to attract a specific type or types of insects. In one embodiment, control circuit 624 includes a user control to adjust the wavelength of insect-attracting light 608. In another embodiment, control circuit 624 may be set to produce a specific wavelength of insect-attracting light 608. In yet another embodiment, control circuit 624 may include a processor, memory, and stored program(s) to produce variations in wavelengths of insect-attracting light 608 according to a programmed schedule or sequence based on time or other factors.

Referring now to FIG. 6F, a block diagram illustrating components of a light source 108 in accordance with a sixth embodiment of the present invention is shown. Unlike the embodiments illustrated in FIGS. 6A-6E, the light source 108 shown in FIG. 6F is a self-illuminated light source 108. Self-illuminated light sources 108 emit light energy based on chemical or radioactive properties of the light sources 108.

In one embodiment, self-illuminated light source 108 includes a material coated with a phosphorescent paint. Phosphorescent paint is commonly called “glow-in-the-dark” paint, and is made from phosphors such as silver-activated zinc sulfide or doped strontium aluminate, and typically glows a pale green to greenish-blue color. The mechanism for producing light is similar to that of fluorescent paint, but the emission of visible light persists long after it has been exposed to light. Phosphorescent paints have a sustained glow which lasts for up to 12 hours after exposure to light, fading over time. This type of paint has been used to mark escape paths in aircraft and for decorative use applied to walls and ceilings.

In one embodiment, self-illuminated light source 108 includes a material coated with radioluminescent paint. Radioluminescent paint was invented in 1908 and originally incorporated radium-226. Radium paint used zinc sulfide phosphor, usually trace metal doped with copper (for green light), silver (blue-green), and more rarely copper-magnesium (for yellow-orange light). The phosphor degrades relatively fast and the painted surfaces lose luminosity in several years to a few decades, despite the long half-life of the Ra-226 isotope (1600 years). The painted surfaces can be renovated by application of a very thin layer of fresh phosphor, without the radium content (with the original material still acting as the energy source); the phosphor layer has to be thin due to the light self-absorption in the material. Radioluminescent paint contains a radioactive isotope (radionuclide) combined with a radioluminescent substance. The isotopes selected are typically strong emitters of fast electrons (beta radiation), preferred since this radiation will not penetrate an enclosure. Radioluminescent paints will glow without exposure to light until the radioactive isotope has decayed (or the phosphor degrades), which advantageously may be many years.

In the second half of the 20th century, radium was progressively replaced with promethium-147. Promethium is only a relatively low-energy beta-emitter, which, unlike alpha emitters, does not degrade the phosphor lattice and the luminosity of the material does not degrade so fast. Promethium-based paints are significantly safer than radium; the half-life of Promethium however, is only 2.62 years.

Instead of radioluminescent paint, one or more Tritium-based self-illuminated light sources 108 may be used in yet another embodiment. The latest generation of the radioluminescent materials is based on tritium, a radioactive isotope of hydrogen with half-life of 12.32 years that emits very low-energy beta radiation. Tritium-based self-illuminated light sources 108 are similar to a fluorescent tube in construction, as they consist of a hermetically sealed (usually borosilicate-glass) tube, coated inside with a phosphor, and filled with tritium. They are known under many names—e.g. gaseous tritium light source (GTLS), traser, or betalight. Tritium light sources 108 are most often seen as “permanent” illumination for the hands of wristwatches intended for diving, nighttime, or tactical use. They are additionally used in glowing novelty key chains, in self-illuminated exit signs, and formerly in fishing lures. They are favored by the military for applications where a power source may not be available, such as for instrument dials in aircraft, compasses, lights for map reading, and weapon sights.

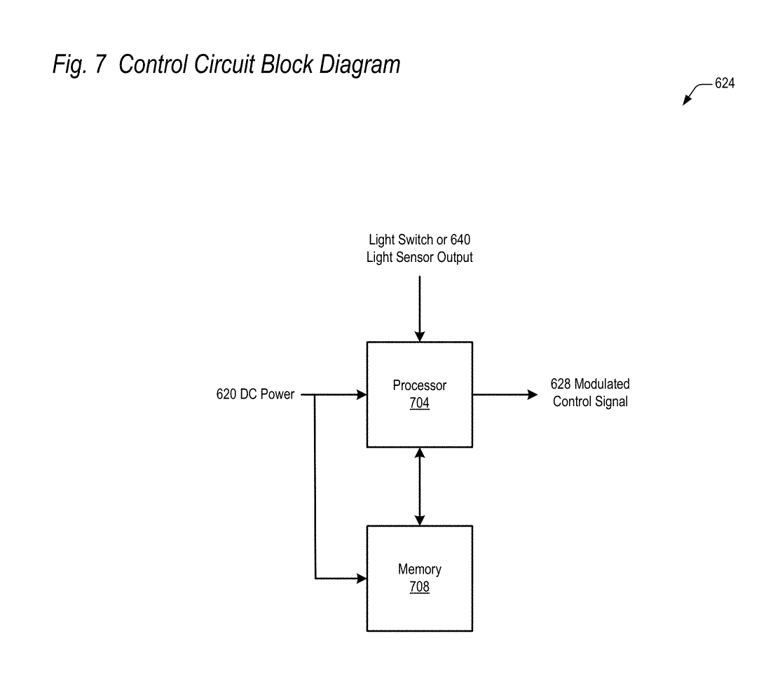

Referring now to FIG. 7, a block diagram illustrating components of a control circuit 624 in accordance with embodiments of the present invention is shown. FIG. 7 illustrates a common embodiment of a control circuit 624. In the preferred embodiment, control circuit 624 includes a processor 704 coupled to a memory device or devices 708. Processor 704 executes computer-readable instructions of the present invention, and may include x86 processors, RISC processors, embedded processors, other types of processors, FPGAs, programmable logic, or pure hardware devices.

Processor 704 interfaces with memory 708, which stores metadata, applications, and/or sensor data. Metadata may include data structures and parameters used in the processes of the present invention. Applications include computer-readable instructions including instructions for light source 108 control processes of the present invention. Sensor data may be data received from light sensor output 640 or from a light switch. Memory 708 may include any combination of volatile and non-volatile memory. Processor 704 outputs a modulated control signal 628 two the light source 108, as described herein. Processor 704 and memory 708 received DC power 620 from a DC power source 612.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel embodiment.

The descriptions and figures included herein depict specific embodiments to teach those skilled in the art how to make and use the best option. For the purpose of teaching inventive principles, some conventional aspects have been simplified or omitted. Those skilled in the art will appreciate variations from these embodiments that fall within the scope of the invention. Those skilled in the art will also appreciate that the features described above can be combined in various ways to form multiple embodiments. As a result, the invention is not limited to the specific embodiments described above, but only by the claims and their equivalents.

Finally, those skilled in the art should appreciate that they can readily use the disclosed conception and specific embodiments as a basis for designing or modifying other structures for carrying out the same purposes of the present invention without departing from the spirit and scope of the invention as defined by the appended claims.

We claim:

1. An insect killing device, comprising:
at least one surface comprising an insecticide therein; and
an attractant light source, in direct contact with the at least one surface, emitting a light that attracts insects to the at least one surface and maintains the insects on the at least one surface.

2. The device of claim 1, wherein the device further comprises one or more of insect attraction pheromones, attraction kairomones, and food attractants.

3. The device of claim 1, wherein the at least one surface is at least one surface of a structure and wherein the attractant light source is located within the structure.

4. The device of claim 1, wherein the at least one surface can be at least partially comprised of a mesh material.

5. The device of claim 4, wherein light emitted by the attractant light source passes through the mesh material.

6. The device of claim 1, comprising an insecticide applied to one or more surfaces of a solid polymer, a polymer fabric, a polymer net, a cellulose pad, a porous polymer pad, or any type of surface on which an insecticide can be applied.

7. The device of claim 1, wherein the insecticide is impregnated into a matrix of a solid polymer, a polymer fabric, a polymer net, a cellulose pad, a polymer pad, or any material that can impregnated with an insecticide for release to the at least one surface.

8. The device of claim 1, wherein the attractant light source comprising one or more self-illuminating light sources.

9. The device of claim 8, wherein the attractant light source comprising one or more radioluminescent light sources.

10. The device of claim 1, wherein the attractant light source comprising one or more of a fluorescent lamp, an incandescent lamp, a light emitting diode, or a plurality of light sources in combination.

11. The device of claim 10, wherein the attractant light source is configured to emit white light, ultraviolet light, or predetermined wavelengths of light.

12. The device of claim 10, wherein the predetermined wavelengths of light are optimized to attract a specific type or types of insects.

13. The device of claim 10, wherein the attractant light source is powered by direct current or alternating current.

14. The device of claim 1, the device further comprising:
a control circuit, coupled to the attractant light source, configured to modulate one or more of an attractant light source brightness and an attractant light source wavelength.

15. The device of claim 14, the device further comprising:
a light sensor, coupled to the control circuit, configured to provide a light sensor output to enable the control circuit when ambient light impinging the light sensor is below a predetermined level.

16. The device of claim 15, wherein the device is configured to only emit light from the light source when the control circuit is enabled.

17. The device of claim 16, wherein the control circuit is configured to maintain the light source brightness in proportion to the light sensor output.

18. The device of claim 1, wherein the device is shaped in any of a variety of configurations, comprising square, triangular, rectangular, diamond, circular, oval, cylindrical, pyramidal, convex, concave, or any geometrical shape.

19. The device of claim 18, wherein the at least one surface is on one or more sides of the device.

20. The device of claim 18, wherein the device is configured to be positioned in order to attract insects to the at least one surface.
